(19) United States
(12) Patent Application Publication
(10) Pub. No.: US 2010/0154173 A1
(43) Pub. Date: Jun. 24, 2010

(54) REPLACEMENT HANDLE WITH POWER SUPPLY

(75) Inventors: JOHN M. KNIGHT, SAINT JOSEPH, MI (US); RICHARD A. MCCOY, STEVENSVILLE, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/341,217

(22) Filed: Dec. 22, 2008

(51) Int. Cl. B25G 1/10; B25G 1/00; E05B 1/00

(52) U.S. Cl. 16/412; 16/110.1; 16/430

(57) ABSTRACT

A handle for a closure can be replaced with a new handle having a power supply. The replacement handle can be for an appliance, a drawer, a door, a cabinet or the like. An interface may communicate with the power supply so as to provide power to a consumer electronic device. Power is provided to the replacement handle by an external source.

### TECHNICAL FIELD

This disclosure relates generally to replacement parts for structures and, more particularly, to a replacement handle for a structure whereby the replacement handle provides power.

The present application is related to the following patent applications filed concurrently herewith: U.S. patent application entitled Adapter Retrofit By Replacement Component bearing applicant's docket number US 20070801, U.S. patent application entitled Handle With Docking Station bearing applicant's docket number US20070831, and U.S. patent application entitled Method Of Providing Replacement Component bearing applicant's docket number US20070832.

### BACKGROUND OF THE INVENTION

Traditionally, appliances, consumer electronic devices, and other useful household machinery are located in a room dedicated to the function supported by the appliance. For example, the kitchen has traditionally been limited to a space for preparing and eating meals and consequently has been mostly occupied by cabinetry and large home appliances such as refrigerators, dishwashers, and ovens. The family room has been designated as a place for leisure activities, and so most entertainment devices, such as televisions and video games are commonly found here. Laundry rooms normally house a washer, dryer, and iron. Devices such as personal computers and printers are often located in another room, such as a dedicated home office or bedroom.

Consumers increasingly own multiple consumer electronic devices (CEDs), such as hand-held electronic devices, laptops, cell phones, PDAs, digital cameras, video recorders, and digital music players. These devices are typically used in many different rooms in the house and are often carried from room to room throughout the home. Consumers also tend to perform non-traditional tasks in the traditional rooms of the home. For example, consumers also tend to eat in the living room or media room, instead of the dining room. Consumers tend to eat, meet and entertain in the kitchen, not just the dining room and family room. In fact, the kitchen is often the hub of most household activity. Consumers also tend to work in every room of the home with the adoption of laptop computers, cellular phones, PDA's and wireless networks.

Therefore, there is a trend for consumers to perform non-traditional functions in a household room designed for a traditional function. The disclosure recognizes this trend and attempts to support the trend.

### BRIEF SUMMARY OF THE INVENTION

According to an illustration of the disclosure, a replacement handle for a structure is provided that allows a consumer to replace an existing handle with a new handle that is operable to receive power. The replacement handle may receive power from a proximity device which in turn is in communication with an electrical service that is external of the structure. Power also could be supplied from within the replacement handle. The replacement handle may include a docking station associated therewith which provides an interface for a consumer electronic device (CED).

### BRIEF DESCRIPTION OF THE DRAWINGS

FIG. 1A is an illustration of a traditional dresser drawer;

FIG. 1B is an illustration of a traditional door;

FIG. 1C is an illustration of a traditional refrigerator;

FIG. 1D is an illustration of a traditional cabinet;

FIG. 2 illustrates an appliance embodying the invention wherein a replacement handle provides power;

FIG. 3 illustrates a dresser with a replacement handle that provides power;

FIG. 4 illustrates a door with a replacement handle that provides power;

FIG. 5 illustrates a cabinet with a replacement handle that provides power.

### DETAILED DESCRIPTION OF THE INVENTION

Referring now to the drawings, preferred embodiments of the present invention are shown in detail. Although the drawings represent embodiments of the present invention, the drawings are not necessarily to scale and certain features may be exaggerated to better illustrate and explain the present invention. The embodiments set forth herein are not intended to be exhaustive or otherwise limit the invention to the precise forms disclosed in the following detailed description.

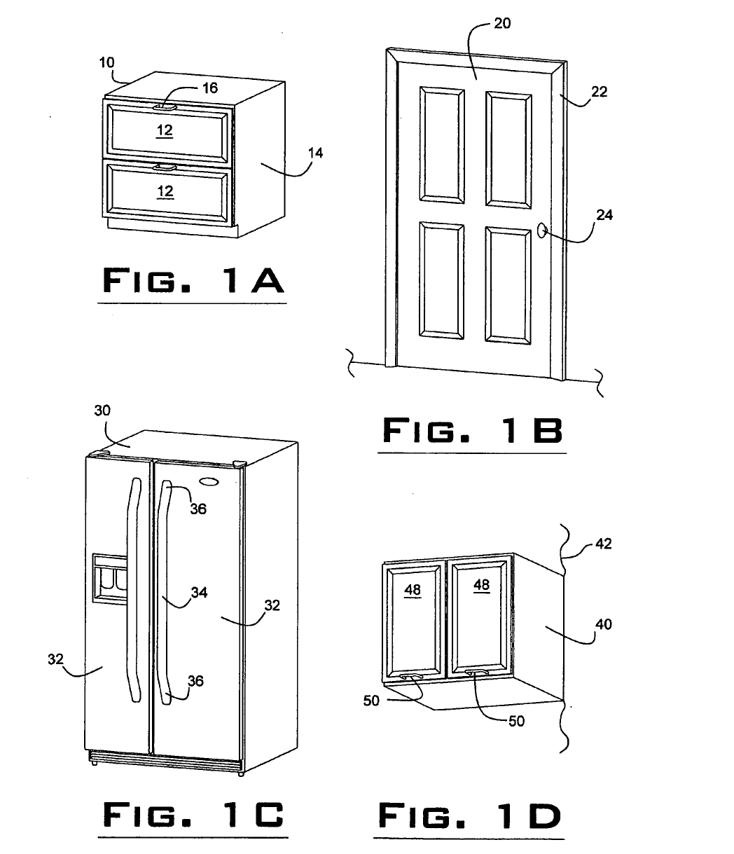

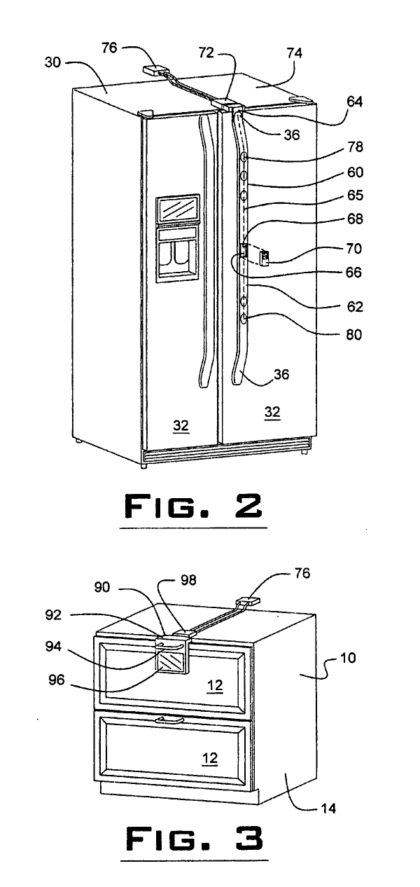

FIG. 1A illustrates a traditional dresser 10 that a consumer may use within a household which can be utilized for placing clothes therein. While a two drawer dresser is illustrated, it will be appreciated that dressers of different size and configurations are contemplated herein. A standard dresser 10 has one or more drawers 12 that are slidably disposed about its base 14. Handles 16 of the conventional type are often secured to an upper surface of the drawer 12. The handle 16 is affixed to the drawer 12 via conventional means and can be replaced when desired.

FIG. 1B illustrates a door assembly having a door 20 secured within a jam 22. A conventional handle 24 aids the consumer in opening and closing the door 20.

FIG. 1C illustrates an appliance 30, for example a refrigerator, with a pair of closure members, or doors 32. A standard handle 34 is secured at mounting points 36 to the doors 32 so as to aid in the opening and closing of the doors 32.

FIG. 1D illustrates a cabinet 40 that could be secured to a wall 42 in a home via conventional means. The cabinet 40 has doors 48 with handles 50 affixed to the lower end thereof. FIGS. 1A-1D illustrate a variety of closing structures that employ closure members which in turn each possess their own handle arrangement. It will be appreciated that the present invention contemplates other structures having closure members and associated handles that need to be replaced wherein power is desired. Set forth below are examples of a few of the possibilities.

FIG. 2 illustrates one aspect of the present invention. A replacement handle assembly 60 includes a handle 62 having power therein. The replacement handle assembly 60 replaces the handle 34 depicted in FIG. 1C. This is accomplished by removing the fasteners positioned at the mounting points 36, removing the former handle 34, and installing the replacement handle assembly 60. It will be appreciated that other means can be used to locate the handle 62 relative to the door 32 such as an attachment interface with a magnetic communication surface, an adhesive surface, a velcronic communication surface, a threaded surface configured to mechanically communicate with a compatible threaded component, a gripable surface configured to provide at least two points for attaching two portions of a gripping device, a slot for holding a portion of a component, a ledge for holding a portion of a component, a clasp, a bolt, a screw, a hook, a shelf, a frame, a pouch, a drawer, or a vice.

The replacement handle assembly 60 includes handle 62, a first proximity device 64, a power and/or data pathway 65, and a power source 66. The handle 62 includes an adapter 68 which may operate as a docking station receiving a consumer electronic device (CED) 70. The power source 66 is in communication with the adapter 68 at one location, and extends to the first proximity device 64, and a power source 66. The handle 62 includes an adapter 68 which may operate as a docking station receiving a consumer electronic device (CED) 70. The power source 66 is in communication with the adapter 68 at one location, and extends to the first proximity device 64 located at another location of the handle. The first proximity device 64 in turn communicates with a second proximity device 72 that may be affixed to a surface 74 of the appliance 30. The second proximity device 72 is connected to an electrical service 76 by wires. Electrical service 76 may receive its power source externally of the appliance 30, or alternatively a source associated with the device 30.

The handle 62 includes other CEDs 78 that can be either permanently affixed to the handle 62, or disconnected from the handle 62. The handle 62 may also include speakers 80 to provide sound in the event CED 70 is an MP3 player or the like. The power pathway 65 connects the speakers 80 to the CED 70.

The adapter 68 is configured to receive the CED 70, or alternatively, the CED 70 could be permanently positioned within the adapter 68. Although the CED 70 illustrated is a music player, the CED is any other consumer electronic device, such as, but not limited to, a television, a video camera, a video recorder, a personal computer, a notebook computer, a computer monitor, a video display, a keyboard, a printer, copying equipment, calculator, facsimile machine, scanner, digital storage device, wireless transceiver, an internet router, a power supply, a data recorder, an answering machine, a telephone, a cordless telephone, a video game system, a personal digital assistant, a DVD player, a VHS player, a VCR, a cassette deck, an 8 millimeter video player, a CD player, a blackberry, a portable digital video player, an MP3 player, a radio, an audio speaker, a digital picture frame, or a weather station.

The replacement handle assembly 60 provides a first function of providing a consumer a device to pull on in order to open up the door 32. The replacement handle assembly 60 further provides the function of adding power to the handle 62 which in turn can be utilized by a CED 70. In addition, the replacement handle assembly 60 can be utilized to transmit data therein as well as, or distinct from, providing power. It will be appreciated that the CED 70 could be a device that receives information or data and transfers same through the handle 62, to the proximity device 72, and out to the electrical service 76. It will be appreciated that the electrical service 76 can provide a service other than the service of providing power. For example, the electrical service 76 can provide data or other information which in turn can be communicated to one or more of the CEDs 70, 78.

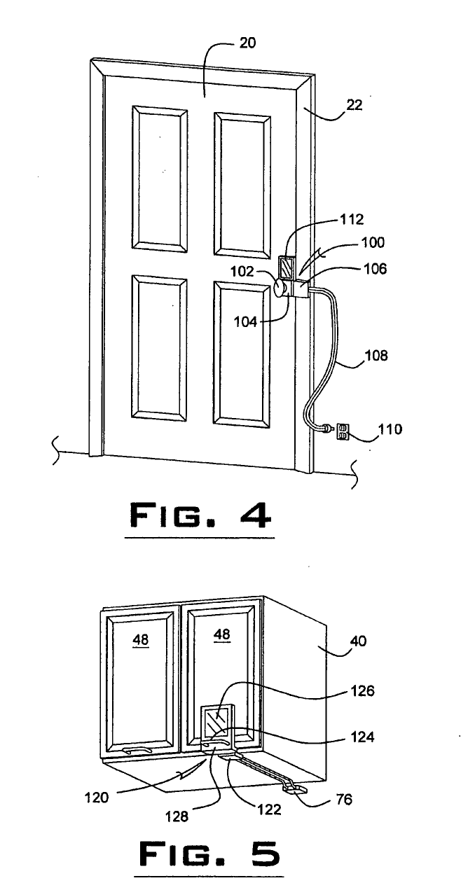

With reference to FIG. 3, the dresser 10 includes a replacement handle assembly 90 that includes a proximity mounting portion 92, a handle 94, and an associated CED 96. While the CED 96 is shown integral with the replacement handle assembly 90, it will be appreciated that the CED 96 could be a separate component wherein an adapter could be employed in association with the replacement handle assembly 90. The proximity mounting portion 92 communicates with a first proximity device 98 which is mounted to a surface of the dresser 10. An electrical service 76 provides power and/or data or perhaps another service to the first proximity device 98 which in turn communicates same to the replacement handle assembly 90. The replacement handle assembly 90 is operable to receive power from the electric service 76.

When the consumer pulls the handle 94, the drawer 12 is free to pull away from the base 40. The replacement handle assembly 90 may include a chargeable battery that allows the CED base to continue to operate when the drawer 12 is positioned away from the first proximity device 98. This chargeable battery concept may be applied to the other replacement handle assemblies discussed herein. When the drawer 12 is moved to a closed position, as shown, the proximity mounting portion 92 regains communication with the first proximity device 98 thus reengaging communication with the electrical service 76.

With reference to FIG. 4, the replacement handle assembly 100 includes a handle 102 and a first proximity device 104 affixed to the door 20. The replacement handle assembly 100 replaces the handle 24 that was discussed in FIG. 1B. A second proximity device 106 is secured to the door jam 22 and a power cord 108 can be plugged into an outlet 110 using a conventional plug. The replacement handle assembly 100 receives power from the outlet 110 which in turn provides the handle 102 with power. Associated with the handle 102 can be a CED 112 of the type discussed above. The first proximity device 104 may include an adapter or docking station for receiving the CED 112. The first proximity device 104 may also include a voltage reduction device that is operable to convert the 115 volts from the outlet 110 to a lower voltage, for example 5 volts. Thus, the CED 112 could be of the type that uses low voltage.

With reference to FIG. 5, the cabinet 40 includes a replacement handle assembly 120 that includes a first proximity device 122 and a handle 124 associated therewith. A CED 126 is associated with the replacement handle assembly 120 and may be integral therewith. Power lines connect the first proximity device 122 to the electrical service 76. A second proximity device portion 128 forms is a lower portion of the replacement handle assembly 120. The first proximity device 122 and the second proximity device portion 128 are juxtaposed to one another when the door 48 is in a closed position (as shown). When the door 48 is open, the first proximity device 122 ceases communication with the second proximity device portion 128, thereby discontinuing any signals there between.

The replacement handle assembly 120 may include a battery back up for allowing continued use of the CED 126. It will be appreciated that speakers can be positioned relative to the cabinet 40, and the CED 126 may provide, remotely or otherwise, signals to said speakers. This of course contemplates the CED 126 being a music type device. It will be appreciated that CED 126 can be many of the other types discussed herein.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed as new and desired to be protected by Letters Patent of the United States is:

1. A handle for an appliance, the handle comprising:
a member connected to a surface of an appliance; and
an electrical source within said member for providing power to an external device.

2. The handle for an appliance as claimed in claim 1, further comprising a proximity device operable to provide power to said member.

3. The handle for an appliance as claimed in claim 1, further comprising a docking station associated with said member.

4. The handle for an appliance as claimed in claim 1, further comprising an electrical service operable to provide power to said handle.

5. The handle for an appliance as claimed in claim 1, wherein said electrical source is a battery.

6. The handle for an appliance as claimed in claim 1, wherein said external device is a consumer electronic device.

7. The handle for an appliance as claimed in claim 1, wherein said member includes a proximity device operable to deliver power to said electrical source within said member.

8. A replacement handle for an enclosure device, the replacement handle comprising:
a hand grip portion;
a power distribution device associated with said hand grip portion; and
a power using device receiving power from said power distribution device.

9. The replacement handle for an enclosure device as claimed in claim 8, wherein said power using device is a consumer electronic device.

10. The replacement handle for an enclosure device as claimed in claim 8, wherein said power distribution device includes a proximity device for delivering power to said hand grip from an external source.

11. The replacement handle for an enclosure device as claimed in claim 8, wherein said power using device is detachable from said handle.

12. The replacement handle for an enclosure device as claimed in claim 8, wherein said hand grip portion is connected to an enclosure device.

13. The replacement handle for an enclosure device as claimed in claim 8, wherein said power distribution device is a battery.

14. The replacement handle for an enclosure device as claimed in claim 8, further comprising a proximity interface for receiving electrical service to the power distribution device.

15. A handle for a closure member, the handle comprising:
a first portion attachable to a closure member; and
a second portion including an electrical interface.

16. The handle for a closure member as claimed in claim 15, further comprising a consumer electronic device operable to engage said electrical interface.

17. The handle for a closure member as claimed in claim 15, further comprising an electrical service providing power to said electrical interface.

18. The handle for a closure member as claimed in claim 15, further comprising a docking station at one of said portions.

19. The handle for a closure member as claimed in claim 15, wherein said closure member is one of a door and drawer.

20. The handle for a closure member as claimed in claim 15, wherein said first and second portions are replacement components that replace an existing handle on said closure member.

21. A handle for a closure member, the handle comprising:
a first portion attachable to a closure member; and
a second portion including a mechanical enclosure for holding a component having a user functionality.

22. The handle of claim 21 wherein the mechanical enclosure is configured to enclose at least a portion of the component having a user functionality.

23. The handle of claim 22 wherein the mechanical enclosure is configured to enclose one of a display screen, a user interface, a music device, video game component, a speaker, a device capable of network communication, a picture, a camera, a phone, and a device capable to render an image.

24. The handle of claim 22 wherein the mechanical enclosure is configured to hold one of a display screen, a user interface, a music device, video game component, a speaker, a device capable of network communication, a picture, a camera, a phone, and a device capable to render an image.
